(19) United States
(12) Patent Application Publication
(10) Pub. No.: US 2023/0188638 A1
(43) Pub. Date: Jun. 15, 2023

(54) CONTROL METHOD AND DEVICE

(71) Applicant: ZTE Corporation, Shenzhen (CN)

(72) Inventors: Xipeng LI, Shenzhen (CN); Yulai LUO, Shenzhen (CN); Xiaoliang ZHANG, Shenzhen (CN); Hairong MA, Shenzhen (CN); Qiuying LIU, Shenzhen (CN)

(21) Appl. No.: 16/754,573

(22) PCT Filed: Jun. 25, 2018
(86) PCT No.: PCT/CN2018/092581

§ 371 Date: Aug. 28, 2020

(30) Foreign Application Priority Data
Oct. 10, 2017 (CN) 201710936723.6

(51) Int. Cl. H04M 1/72454; H04M 1/72403; G06F 3/041

(52) U.S. Cl. CPC H04M 1/72454; H04M 1/72403; G06F 3/0414; G06F 3/0412; G06F 2203/04105

(57) ABSTRACT

Provided are a control method and device. The method includes: acquiring at least one piece of following touch information: first fingerprint touch information on a first touch screen of a terminal or second fingerprint touch information on a second touch screen of the terminal; and controlling the terminal according to the acquired touch information.

### CROSS-REFERENCE TO RELATED APPLICATIONS

This is a National Stage Application, filed under 35 U.S.C. 371, of International Patent Application No. PCT/CN2018/092581, filed on Jun. 25, 2018, which claims priority to Chinese patent application No. 201710936723.6 filed on Oct. 10, 2017, contents of both of which are incorporated herein by reference in their entireties.

### TECHNICAL FIELD

The present disclosure relates to the technical field of communications, for example, relates to a control method and device.

### BACKGROUND

With the rapid development of a smart terminal technology and the reduction of component costs, the development of a dual-screen terminal technology will become a popular trend. A dual-screen terminal can enable the terminal to adapt to more usage scenarios and is more portable, thus bringing a better user experience effect than a single-screen terminal.

Moreover, through the rapid development for many years, a touch technology of the terminal has become quite mature. From a resistance screen to a capacitive screen and then to a pressure screen, novel technologies related to the screen touch of the smart terminal emerge continuously, which brings a better operation experience to users.

However, if the screen touch technology of the single-screen terminal is used in the double-screen terminal, there are still deficiencies in use of the touch operation.

### SUMMARY

Embodiments of the present application provide a control method and device to at least solve that terminal control methods in the related art are all based on a single-screen terminal and no control method for multiple screens has been proposed.

The present application provides a control method applied to a terminal including at least two touch screens and the method includes the following steps: at least one piece of the following touch information is acquired: first fingerprint touch information on a first touch screen of the terminal and second fingerprint touch information on a second touch screen of the terminal; and the terminal is controlled according to the acquired touch information.

The present application provides a control device applied to a terminal including at least two touch screens and the device includes an acquisition module and a control module. The acquisition module is configured to acquire at least one piece of the following touch information: first fingerprint touch information on a first touch screen of the terminal and second fingerprint touch information on a second touch screen of the terminal. The control module is configured to control the terminal according to the acquired touch information.

The present application further provides a storage medium including a stored program, where the program, when executed, performs the above-mentioned method.

The present application further provides a processor, which is configured to execute a program, where the program, when executed, performs the above-mentioned method.

The present application provides a corresponding control method for characteristics of touch operations of the multi-screen terminal, thereby solving that the terminal control methods in the related art are all based on the single-screen terminal and no control method for the multiple screens has been proposed, and effectively improving the user experience for the multi-screen terminal.

### BRIEF DESCRIPTION OF DRAWINGS

FIG. 1 is a structural block diagram of hardware of a mobile terminal for a control method according to an embodiment of the present application;

FIG. 2 is a flowchart of a control method according to an embodiment of the present application;

FIG. 3 is a flowchart of a control method according to an embodiment of the present application;

FIG. 4 is an operation schematic diagram according to an embodiment of the present application;

FIG. 5 is a flowchart of a control method according to another embodiment of the present application;

FIG. 6 is an operation schematic diagram according to another embodiment of the present application;

FIG. 7 is a flowchart of a control method according to another embodiment of the present application;

FIG. 8 is an operation schematic diagram according to another embodiment of the present application;

FIG. 9 is a flowchart of a control method according to another embodiment of the present application;

FIG. 10 is an operation schematic diagram according to another embodiment of the present application;

FIG. 11 is a flowchart of a control method according to another embodiment of the present application;

FIG. 12 is an operation schematic diagram according to another embodiment of the present application;

FIG. 13 is a flowchart of a control method according to another embodiment of the present application;

FIG. 14 is a structural block diagram of a control device according to an embodiment of the present application;

FIG. 15 is a structural block diagram of a control device according to another embodiment of the present application;

FIG. 16 is a structural block diagram of a control device according to another embodiment of the present application;

FIG. 17 is a structural block diagram of a control device according to another embodiment of the present application; and

FIG. 18 is a structural block diagram of a control device according to another embodiment of the present application.

### DETAILED DESCRIPTION

The present application will be described hereinafter with reference to the drawings and in conjunction with the embodiments. If not in collision, the embodiments and features therein in the present application may be combined with each other.

The terms “first”, “second” and the like in the description, claims and drawings of the present application are used for distinguishing between similar objects and are not necessarily used for describing a particular order or sequence.

A screen touch technology based on a single-screen terminal is used in a dual-screen terminal, for example, for processing of complex touch operation behaviors performed by a user on the dual-screen terminal simultaneously, there is a lack of a processing scheme for simultaneous occurrence of touch events on the dual-screen terminal. Moreover, for the dual-screen terminal, especially for a dual-screen terminal supporting a pressure screen, there is also a lack of a corresponding touch operation technical scheme in a pressure screen technology for the dual-screen terminal.

### Embodiment One

A method embodiment provided by embodiment one of the present application may be performed in a mobile terminal, a computer terminal, or a similar computing device. Taking the method embodiment being executed on the mobile terminal as an example, FIG. 1 is a structural block diagram of hardware of a mobile terminal for a control method according to an embodiment of the present application. As shown in FIG. 1, a mobile terminal 110 may include one or more (only one processor is shown in FIG. 1) processors 111 (the processor 111 may include, but is not limited to, a processing device such as a microcontroller unit (MCU) or a field-programmable gate array (FPGA)), a memory 112 configured to store data and a transmission device 113 configured to communicate. Those of ordinary skill in the art may understand that the structure shown in FIG. 1 is merely illustrative and FIG. 1 does not limit the structure of the above-mentioned electronic device. For example, the mobile terminal 110 may further include more or fewer components than that shown in FIG. 1, or have different configuration than that shown in FIG. 1.

The memory 112 may be configured to store software programs and modules of application software, such as a program instruction/module corresponding to the control method in the embodiment of the present application. The processor 111 performs various functional applications and data processing by executing the software programs and the modules stored in the memory 112, that is, implements the above-mentioned method. The memory 112 may include a high-speed random access memory and may further include a nonvolatile memory, such as one or more magnetic storage devices, flash memories, or other nonvolatile solid-state memories. In some examples, the memory 112 may include memories remotely disposed relative to the processor 111, and the remote memories may be connected to the mobile terminal 110 via a network. Examples of the above-mentioned network include, but are not limited to, the Internet, an intranet, a local area network, a mobile communication network, and combinations thereof.

The transmission device 113 is configured to receive or transmit data via a network. Examples of the above-mentioned network may include a wireless network provided by a communication provider of the mobile terminal 110. In an example, the transmission device 113 includes a network interface controller (NIC), which may be connected to other network devices through a base station to communicate with the Internet. In an example, the transmission device 113 may be a radio frequency (RF) module, which is configured to communicate with the Internet in a wireless manner.

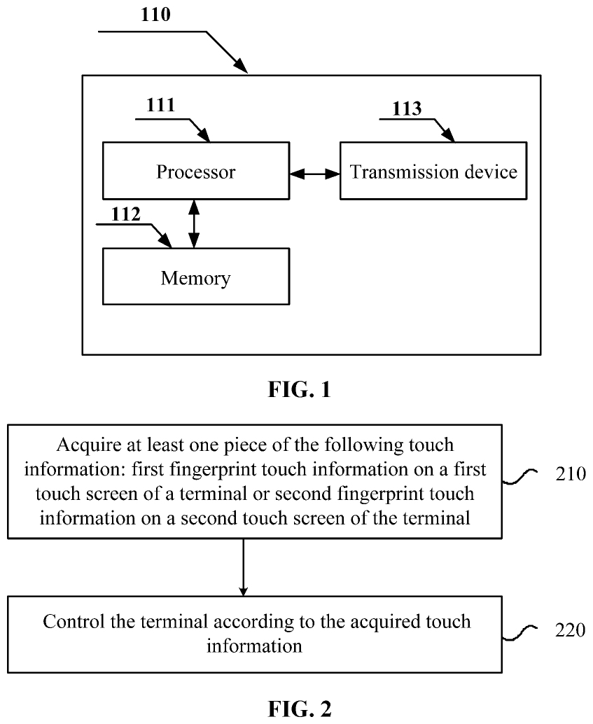

This embodiment provides a control method applied to a terminal, where the terminal includes at least two touch screens. FIG. 2 is a flowchart of the control method according to this embodiment. As shown in FIG. 2, the process includes the steps described below.

In step 210, at least one piece of the following touch information is acquired: first fingerprint touch information on a first touch screen of the terminal and second fingerprint touch information on a second touch screen of the terminal.

In step 220, the terminal is controlled according to the acquired touch information.

FIG. 3 is a flowchart of a control method according to this embodiment. As shown in FIG. 3, the method includes the steps described below.

In step 202, the first fingerprint touch information on the first touch screen of the terminal is acquired.

In an embodiment, the above-mentioned first fingerprint touch information includes at least one of the following: a pressure value, a touch region area, an ultrasonic wave or a light wave.

In step 204, the second fingerprint touch information on the second touch screen of the terminal is acquired.

In an embodiment, the above-mentioned second fingerprint touch information includes at least one of the following: a pressure value, a touch region area, an ultrasonic wave or a light wave.

In step 206, the terminal is controlled according to the first fingerprint touch information and the second fingerprint touch information.

Through the above-mentioned step 202 to step 206, the first fingerprint touch information on the first touch screen of the terminal is acquired; the second fingerprint touch information on the second touch screen of the terminal is acquired; and the terminal is controlled according to the first fingerprint touch information and the second fingerprint touch information. That is, a corresponding control method for characteristics of touch operations of a multi-screen terminal is provided, thereby solving that terminal control methods in the related art are all based on a single-screen terminal and no control method for multiple screens has been proposed, and effectively improving the user experience for the multi-screen terminal.

This embodiment is illustrated below in conjunction with an example.

This example provides a smart terminal supporting multiple screens and a control method designed for a multi-screen terminal. A principle of a technical scheme of this embodiment includes the following: for a terminal supporting dual screens, two screens may simultaneously or independently detect an operation of pressing or sliding applied by multiple fingers of a user to the two screens, and the terminal may implement a function and application expected by the user through real-time detection and determination processing of conditions such as, distributed on the two screens, coordinates or a sliding variation trend of coordinate points of one or more finger pressing points, the magnitude of the pressure or a variation trend of the pressure, and the area of a finger surface or a variation trend of the area of the finger surface.

In an embodiment, a scenario of the real-time detection and the determination processing includes, but is not limited to, multi-point touch recognition on the multiple screens; data values of sampling points in a region range of multi-point pressing (contact) of multiple fingers; information about coordinate points of finger mark positions of multi-point pressing (contact) of multiple fingers; pressing (contact) time of a multi-point pressing region; a calculated value of a multi-point pressing (contact) time period; a pressure value set of sampling points in a pressing region; a pressure value of a mark pressure point; a trend value of a pressure variation of a pressure point; a touch region area; a touch time period; a variation trend of the touch region area; detection of a finger surface sliding operation; correspondence and conversion of a coordinate system; recognition of a finger touch operation on an acoustic wave touch screen; and recognition of a finger touch operation on a light wave touch screen.

The recognition of the finger touch operation on the acoustic wave touch screen: For a terminal supporting the acoustic wave touch screen, when the screen is pressed (contacted) by multiple points of multiple fingers, acoustic waves on the contacted points are prevented, such that information about the outline shape of the multiple fingers and information about coordinate points of mark positions of the multiple fingers may be determined.

The recognition of the finger touch operation on the light wave touch screen: For a terminal supporting the light wave touch screen, when the screen is pressed (contacted) by multiple points of multiple fingers, light waves on the contacted points are prevented, such that information about the outline shape of the multiple fingers and information about coordinate points of mark positions of the multiple fingers may be determined.

The multi-point touch recognition on the multiple screens: A dual-screen terminal supports multi-point touch pressing recognition from fingers of a user, and supports recognizing the number of finger surfaces of fingers of the user touching a touch panel of the mobile phone simultaneously within the same time period, and the finger surfaces of the fingers of the user are effectively recognized by the touch panel. In an embodiment, the dual-screen terminal may distinguish which touch points correspond to which screens are touched.

The data values of the sampling points in the region range of the multi-point pressing of the multiple fingers is a set of coordinate points where a finger surface of each finger of the user effectively contacts the touch panel. The set of the coordinate points may reflect a region where a finger surface region of the finger of the user effectively contacts the touch panel and is recognized by the touch panel, and the area of the region is determined by the size of a region where the finger surface contacts the touch panel and is effectively recognized by the touch panel. The coordinate set is converted to a coordinate set of the sampling points by a processing unit of the terminal, and density of the sampling points may be set according to conditions such as hardware processing capability and the level of touch operation experience of the user.

The information about the coordinate points of the finger mark positions of the multi-point pressing (contact) of the multiple fingers: A coordinate value of a mark position pressed by the user is generated according to the set of the coordinate points where the finger surface of each finger of the user effectively contacts the touch panel. The coordinate value corresponds to information about the touch point of the finger of the user, and may be used for determining how many finger surfaces of the user contacts the touch panel of the terminal within the same time period, and a physical position or region information corresponding to each finger surface.

In an embodiment, information values of the coordinate points of the finger mark positions may be calculated from the set of the coordinate points where the finger surface effectively contacts the touch panel through a preset condition. A calculation method includes, but is not limited to, the following steps: a coordinate value of an approximate average center point or an average value of a center point coordinate region of a regular or irregular region is calculated; it is determined whether there is an obvious boundary between adjacent multi-point pressing regions; and finger surface shapes of multiple finger surfaces which approximate circular patterns are determined by a fuzzy recognition technology, so as to distinguish state information that multiple different finger surfaces of the user simultaneously contact the touch panel.

The pressing time of the multi-point pressing region: The terminal detects and records time information of multiple finger surfaces of the user contacting the touch plane within the same time period. The time information includes, but is not limited to, the starting time when each finger surface of the user contacts the touch plane and the separating time when the each finger surface of the user separates from the touch plane.

The calculated value of the multi-point pressing time period is the time, detected and recorded by the terminal within the same time period, from the starting time when multiple finger surfaces contact the touch panel to the separating time.

The pressure value set of the sampling points in the pressing region is a value set of the pressing pressure corresponding to multiple coordinate points in a set of coordinate points of the finger surface of the finger of the user when the finger surface of the finger of the user effectively contacts the touch panel.

The pressure value of the mark pressure point is a mark pressure value of each finger surface calculated according to information about the pressure value set of the sampling points in the pressing region by a preset condition. A calculation range of the mark pressure value may be calculated individually for each finger surface according to distinguished states that the multiple different finger surfaces of the user contact the touch panel simultaneously. A calculation method includes, but is not limited to, the following steps: an average value is taken according to pressure values of all coordinate points in the pressure value set of the sampling points in the pressing region; a pressure value of a coordinate position of a coordinate point of a finger mark position is taken; and a pressure value of the maximum pressure point in the pressure value set of the sampling points in the pressing region is taken.

The trend value of the pressure variation of the pressure point: The trend value of the pressure variation within a time interval is determined according to the variation of the magnitude of a pressure value of a sampling point in the pressing region within the time interval. The trend value of the pressure variation includes, but is not limited to, the pressing pressure of the pressure point varying from small to large; the pressing pressure of the pressure point varying from large to small.

The touch region area is the value of the area that the finger surface of the finger effectively contacts the touch panel. The value may be obtained by calculation from the data values of the sampling points in the region range of the multi-point touching of the multiple fingers. A calculation method includes, but is not limited to, the following steps: coordinate values of boundary points in sampling points in a region range touched by the finger surfaces, a geometric figure is generated through a linear approximation algorithm, and the area of the geometric figure is calculated.

The touch time period is a time period value, detected and recorded by the terminal, from the starting time when the finger surface of the finger contacts the touch plane to the separating time. A parameter value of the touch time period needs to be preset. A parameter setting rule includes, but is not limited to, the following: a time period from the finger surface effectively contacting the touch panel to the finger surface effectively separating from the touch panel; a time period during which the touch region area varies from small to large or from large to small and reaches a preset threshold value when the finger surface contacts the touch panel.

The variation trend of the touch region area: A value of the variation trend of the touch region area within an interval of the touch time period is determined according to the variation of the touch region area within the interval of the touch time period. The value of the variation trend of the area includes, but is not limited to, a value of changing from small to large, a value of changing from large to small, a value of changing from small to large and then to small, a value of changing from large to small and then to large.

The detection of the finger surface sliding operation: The terminal may detect an sliding operation of finger surfaces of one or more fingers on the screen, and may distinguish dual-screen information corresponding to each finger surface. A detection method includes, but is not limited to, the following step: the terminal may perform a corresponding processing operation according to a connected coordinate movement variation of coordinates of coordinate points of finger mark positions occurred on the screen based on a certain geometric figure line, and when a geometric direction or distance of the coordinate movement variation reaches a preset threshold value.

The correspondence and conversion of the coordinate system is a processing method of correspondence and conversion of coordinate systems of the two screens. When two screens of the dual-screen terminal are unfolded in a plane and folded in a back direction, a correspondence between coordinate systems of the two screens needs to be converted. In order to implement the control method provided in this example, the screens of the terminal may be illustrated in a folded state and an unfolded state.

The screen unfolded state: Each of two screens corresponds to a respective one coordinate system, coordinate values at the same position in the two coordinate systems are the same, and the difference is that the coordinate value is on a left side of the screens (a left screen) or a right side of the screens (a right screen). Assuming that a coordinate of a point A on the left screen is A (x, y), a coordinate of a coordinate point B corresponding to the same position on the right screen is B (x, y).

The screen folded state: A coordinate system of a front screen differs 180° from a coordinate system of a back screen in a horizontal direction. That is, the coordinate system of the front screen is in one-to-one correspondence with a back surface of the back screen. Assuming that the coordinate system of the front screen is a reference coordinate system, and a coordinate of a touch point A on the back screen is A (x, y), the coordinate of the point A on the back screen is converted and corresponded to the front screen, and then a converted coordinate value is A′ (−x, y).

The screen unfolded state and the screen folded state are relative, and calculation methods of coordinate systems in the two states are different. A critical angle value may be defined, for example, when an angle between the two screens is greater than 120°, the coordinate systems are automatically switched to coordinate systems corresponding to the unfolded state, otherwise, the coordinate systems correspond to the coordinate systems in the folded state.

In an embodiment, the step in which the terminal is controlled according to the first fingerprint touch information and the second fingerprint touch information includes the steps described below.

In the case where the first fingerprint touch information or the second fingerprint touch information includes the pressure value, a coordinate point of a mark position of a force bearing point of the first fingerprint touch information is converted onto the second touch screen according to a predetermined mode; or a coordinate point of a mark position of a force bearing point of the second fingerprint touch information is converted onto the first touch screen according to a predetermined mode.

It is determined whether a distance between coordinate points of mark positions on the first touch screen or a distance between coordinate points of mark positions on the second touch screen is within a preset range.

In the case where it is determined that the distance between the coordinate points of the mark positions on the first touch screen or the distance between the coordinate points of the mark positions on the second touch screen is within the preset range, the terminal is controlled with the coordinate point of the mark position of the force bearing point of the first fingerprint touch information or the coordinate point of the mark position of the force bearing point of the second fingerprint touch information as a center.

In an embodiment, the step of converting onto the second touch screen or the first touch screen according to the predetermined mode includes the following steps: a state between the first touch screen and the second touch screen is determined according to an angle between the first touch screen and the second touch screen; according to the state between the first touch screen and the second touch screen, the coordinate point of the mark position on the first touch screen is converted onto the second touch screen, or the coordinate point of the mark position on the second touch screen is converted onto the first touch screen.

In an embodiment, the step in which the terminal is controlled according to the first fingerprint touch information and the second fingerprint touch information further includes the steps described below.

In the case where the first fingerprint touch information or the second fingerprint touch information includes the pressure value, coordinate points of one or more force bearing points in the first fingerprint touch information are converted onto the second touch screen, or coordinate points of one or more force bearing points in the second fingerprint touch information are converted onto the first touch screen.

The terminal is controlled according to coordinate system positions where the coordinate points of one or more force bearing points on the first touch screen or on the second touch screen are located.

In an embodiment, the step in which the terminal is controlled according to the first fingerprint touch information and the second fingerprint touch information further includes the steps described below.

The terminal is controlled according to a variation trend of a pressure value indicated by the first fingerprint touch information and a variation trend of a pressure value indicated by the second fingerprint touch information.

In an embodiment, the step in which the terminal is controlled according to the first fingerprint touch information and the second fingerprint touch information further includes the steps described below.

In the case where each of the first fingerprint touch information and the second fingerprint touch information includes the touch region area, the terminal is controlled according to a distance between an average center point of the touch region area of the first fingerprint touch information and an average center point of the touch region area of the second fingerprint touch information.

In an embodiment, before the terminal is controlled according to the distance between the average center point of the touch region area of the first fingerprint touch information and the average center point of the touch region area of the second fingerprint touch information, the method may further include the steps described below.

A first coordinate point set corresponding to the touch region area of the first fingerprint touch information is acquired according to a touch region area received by the first touch screen and a second coordinate point set corresponding to the touch region area of the second fingerprint touch information is acquired according to a touch region area received by the second touch screen.

The first coordinate point set and the second coordinate point set are processed by a specified algorithm to obtain a touch region outline map.

The average center point of the touch region area of the first fingerprint touch information and the average center point of the touch region area of the second fingerprint touch information are acquired according to the touch region outline map.

In an embodiment, the step in which the terminal is controlled according to the first fingerprint touch information and the second fingerprint touch information further includes the steps described below.

In the case where each of the first fingerprint touch information and the second fingerprint touch information includes the touch region area, the terminal is controlled according to a variation trend of the touch region area indicated by the first fingerprint touch information and a variation trend of the touch region area indicated by the second fingerprint touch information.

In an embodiment, before the terminal is controlled according to the first fingerprint touch information and the second fingerprint touch information, the method further includes the step described below.

It is determined that the first fingerprint touch information and the second fingerprint touch information satisfy a preset condition.

In an embodiment, the above-mentioned preset condition includes at least one of the following: values corresponding to the first fingerprint touch information and the second fingerprint touch information are not equal to 0, or contact time corresponding to the first fingerprint touch information and the second fingerprint touch information is within a preset range. In an embodiment, in the case where the acquired touch information includes the first fingerprint touch information and the second fingerprint touch information, the step in which the terminal is controlled according to the acquired touch information includes the steps described below.

In the case where each of the first fingerprint touch information and the second fingerprint touch information includes the pressure value, the coordinate point of the mark position of the force bearing point on the first touch screen is converted onto the second touch screen according to a predetermined mode to obtain a coordinate position, which corresponds to the coordinate point of the mark position of the force bearing point on the first touch screen, on the second touch screen.

It is determined whether a distance between the coordinate position, which corresponds to the coordinate point of the mark position of the force bearing point on the first touch screen, on the second touch screen and a coordinate point of a mark position of a force bearing point on the second touch screen is within a preset range.

In the case where it is determined that the distance between the coordinate position, which corresponds to the coordinate point of the mark position of the force bearing point on the first touch screen, on the second touch screen and the coordinate point of the mark position of the force bearing point on the second touch screen is within the preset range, the terminal is controlled with the coordinate point of the mark position of the force bearing point on the second touch screen as a center.

In an embodiment, in the case where the acquired touch information includes the first fingerprint touch information, the step in which the terminal is controlled according to the acquired touch information includes the steps described below.

In the case where the first fingerprint touch information includes the pressure value, coordinate points of mark positions of at least two force bearing points on the first touch screen are converted onto the second touch screen according to a predetermined mode to obtain at least two coordinate positions, which are in one-to-one correspondence with the coordinate points of the mark positions of the at least two force bearing points on the first touch screen, on the second touch screen.

It is determined whether a distance between every two coordinate positions in the at least two coordinate positions, which are in the one-to-one correspondence, on the second touch screen is within a preset range.

In the case where it is determined that the distance between the every two coordinate positions is within the preset range, the terminal is determined with one of the coordinate points of the mark positions of the at least two force bearing points on the first touch screen as a center.

In an embodiment, in the case where the acquired touch information includes the first fingerprint touch information and the second fingerprint touch information, the step in which the terminal is controlled according to the acquired touch information includes the steps described below.

In the case where each of the first fingerprint touch information and the second fingerprint touch information includes the pressure value, coordinate points of mark positions of one or more force bearing points on the second touch screen are converted onto the first touch screen to obtain one or more coordinate positions, which are in one-to-one correspondence with the coordinate points of the mark positions of the one or more force bearing points on the second touch screen, on the first touch screen.

The terminal is controlled according to coordinate system positions where the one or more coordinate positions, which are in the one-to-one correspondence, on the first touch screen are located and coordinate system positions where the coordinate points of the mark positions of one or more force bearing points on the first touch screen are located.

In an embodiment, in the case where the acquired touch information includes the first fingerprint touch information, the step in which the terminal is controlled according to the acquired touch information includes the steps described below.

In the case where the first fingerprint touch information includes the pressure value, coordinate points of mark positions of one or more force bearing points on the first touch screen are converted onto the second touch screen to obtain one or more coordinate positions, which are in one-to-one correspondence with the coordinate points of the mark positions of the one or more force bearing points on the first touch screen, on the second touch screen.

The terminal is controlled according to coordinate system positions where the one or more coordinate positions, which are in the one-to-one correspondence, on the second touch screen are located.

In an embodiment, in the case where the acquired touch information includes the first fingerprint touch information and the second fingerprint touch information, and each of the first fingerprint touch information and the second fingerprint touch information includes the pressure value, the step in which the terminal is controlled according to the acquired touch information includes the step described below.

The terminal is controlled according to the variation trend of the pressure value indicated by the first fingerprint touch information and the variation trend of the pressure value indicated by the second fingerprint touch information.

In an embodiment, in the case where the acquired touch information includes the first fingerprint touch information and the second fingerprint touch information, the step in which the terminal is controlled according to the acquired touch information includes the step described below.

In the case where each of the first fingerprint touch information and the second fingerprint touch information includes the touch region area, the terminal is controlled according to the distance between the average center point of the touch region area of the first fingerprint touch information and the average center point of the touch region area of the second fingerprint touch information.

In an embodiment, before the terminal is controlled according to the distance between the average center point of the touch region area of the first fingerprint touch information and the average center point of the touch region area of the second fingerprint touch information, the method further includes the steps described below.

A first coordinate point set corresponding to the touch region area of the first fingerprint touch information is acquired according to the touch region area received by the first touch screen and a second coordinate point set corresponding to the touch region area of the second fingerprint touch information is acquired according to the touch region area received by the second touch screen.

The first coordinate point set and the second coordinate point set are processed by the specified algorithm to obtain the touch region outline map.

The average center point of the touch region area of the first fingerprint touch information and the average center point of the touch region area of the second fingerprint touch information are acquired according to the touch region outline map.

In an embodiment, in the case where the acquired touch information includes the first fingerprint touch information and the second fingerprint touch information, the step in which the terminal is controlled according to the acquired touch information includes the following step: in the case where each of the first fingerprint touch information and the second fingerprint touch information includes the touch region area, the terminal is controlled according to the variation trend of the touch region area indicated by the first fingerprint touch information and the variation trend of the touch region area indicated by the second fingerprint touch information.

In an embodiment, before the terminal is controlled according to the acquired touch information, the method further includes the following step: it is determined that at least one piece of the acquired touch information satisfies a preset condition.

The preset condition includes at least one of the following: a value corresponding to a parameter included in the acquired touch information is not equal to 0, or contact time included in the acquired touch information is within a preset range.

In an embodiment, the step of controlling the terminal includes, but is not limited to, moving an application icon, controlling the size of an application interface, waking up and unlocking the terminal, performing dual-screen photographing.

This embodiment is illustrated below in conjunction with optional embodiments.

### Optional Embodiment One

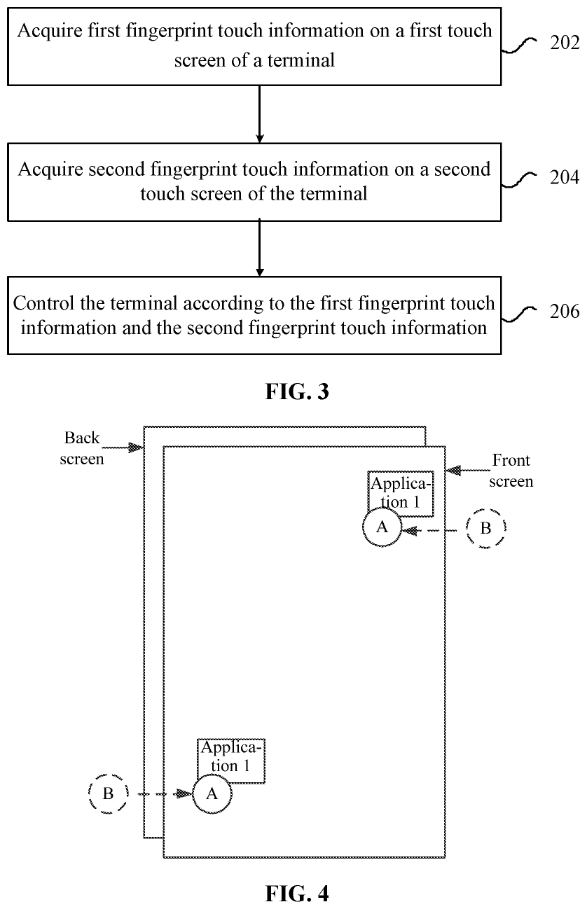

In this optional embodiment, moving an application icon is mainly applied. FIG. 4 is an operation schematic diagram according to optional embodiment one. As shown in FIG. 4, two screens of a terminal are folded in half, a front screen faces a user and is in a lighting state, and a back screen is in an off state. Assuming that the terminal has two standby desktops at present, the front screen displays desktop one and the back screen displays desktop two in a lighting state. At this time, a user presses an icon of an application 1 on desktop one with finger surfaces of two fingers simultaneously, when pressing time or a pressing pressure value reaches a preset condition, the icon of the application 1 becomes active, and at the same time, desktop one is switched to desktop two to display on the front screen. At this time, the user may move the icon of the application 1 to top right of the screen through operations of double finger pinching and moving on the front screen and the back screen and release the fingers. At this time, the icon of the application 1 disappears from desktop one, desktop two displayed on the front screen is switched back to desktop one, and the icon has been moved to a corresponding position on the back screen. The position of the icon of the application 1 displayed on the back screen may be displayed and calculated according to a conversion between a coordinate system of the front screen and a coordinate system of the back screen.

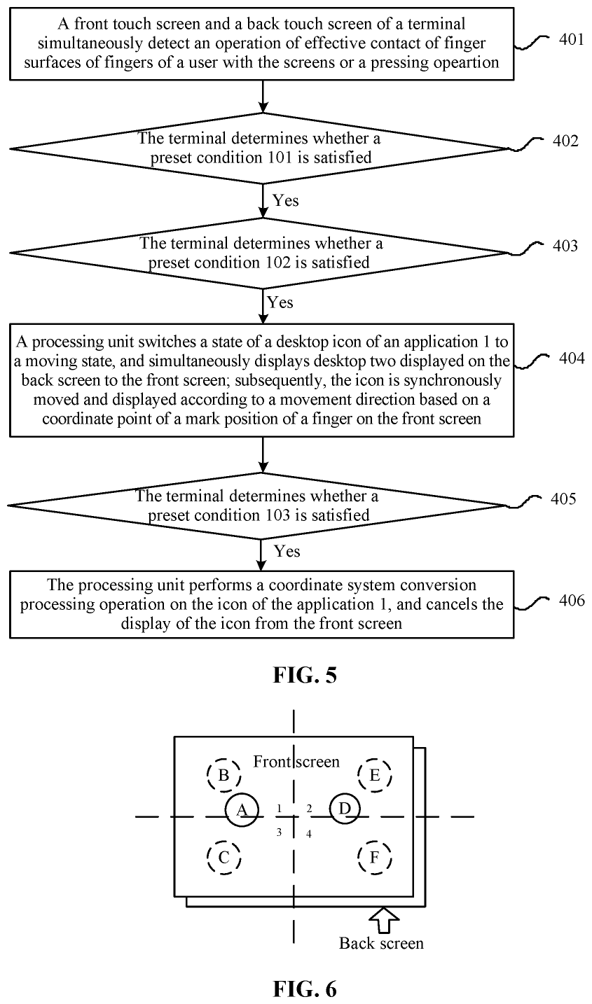

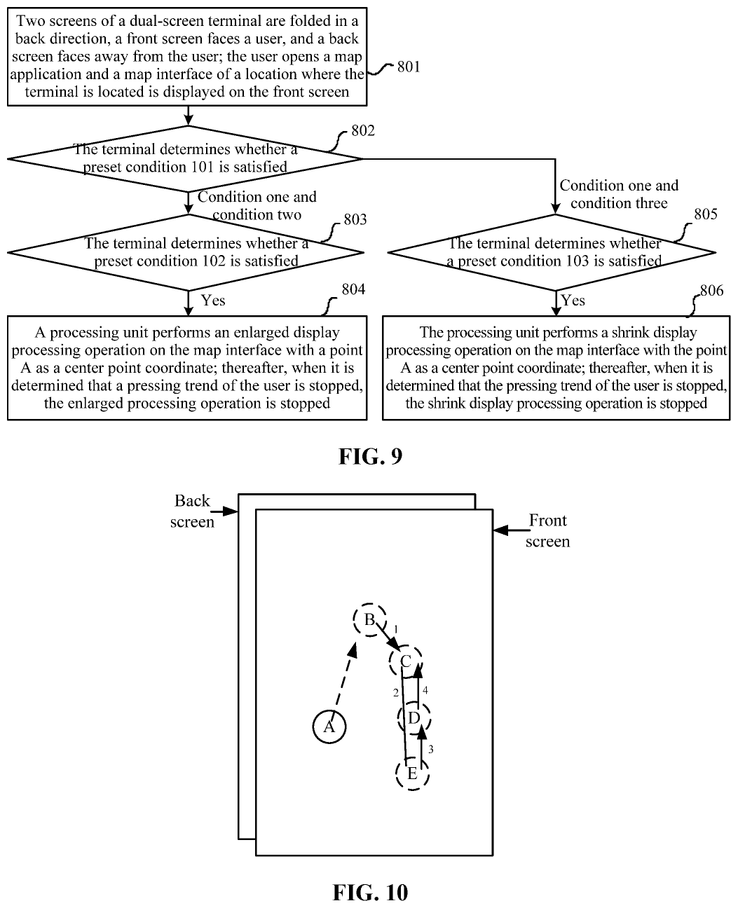

FIG. 5 is a flowchart of a control method according to optional embodiment one. A front touch screen and a back touch screen of the terminal simultaneously detect an operation of effective contact of finger surfaces of fingers of the user with the screens or a pressing operation, and the terminal determines whether a preset condition 101 is satisfied. The preset condition 101: A processing unit detects that finger surfaces of two fingers simultaneously contact the front screen and the back screen of the terminal on the front screen and the back screen. If the preset condition 101 is satisfied, a determination process flow of a preset condition 102 is entered. The terminal detects a touch time period when the finger surface of each finger of the user presses the touch screen or a pressure value of a mark pressure point, and determines whether the preset condition 102 is satisfied. The preset condition 102: In condition one, two fingers on the front screen and the back screen perform a pressing operation simultaneously, and a distance between coordinate points of mark positions of the two fingers after being performed by the conversion between the coordinate system of the front screen and the coordinate system of the back screen is within a preset range; in condition two, a movable application icon is arranged on desktop one within a preset radius range based on a coordinate point of the finger mark position on the front screen as a center; and in condition three, a touch detection unit determines that touch time periods of one or more fingers on the front screen or the back screen reaches a touch time period threshold value or pressure values of mark pressure points of one or more fingers on the front screen or the back screen reach a threshold value of which a pressure variation trend of the pressing point changes from small to large within a pressing time period. When the processing unit determines that the preset condition 102 is satisfied, the processing unit switches a state of a desktop icon of the application 1 to a moving state, and simultaneously displays desktop two displayed on the back screen to the front screen. Subsequently, the icon is synchronously moved and displayed according to a movement direction based on the coordinate point of the mark position of the finger on the front screen. A determination processing flow of a preset condition 103 is entered. The preset condition 103: In condition one, a pressing operation of at least one of the two fingers on the front screen and the back screen ends, and the at least one finger leaves a corresponding screen. When the processing unit determines that the preset condition 103 is satisfied, the processing unit performs a coordinate system conversion processing operation on the icon of the application 1, and cancels the display of the icon from the front screen. In the coordinate system conversion processing operation on the icon of the application 1, assuming that a coordinate of a position where the icon of the application 1 finally moves to on the front screen is A (x, y), after the coordinate of the point A on the front screen is converted and corresponded to the back screen, a new coordinate value that the point A is based on the back screen is A′ (−x, y) (referring to step 401 to step 406 shown in FIG. 9).

### Optional Embodiment Two

In this optional embodiment, a play station portable (PSP) is mainly applied. This optional embodiment relates to a technology and method for screen virtual key touch operation. This embodiment may be applied to a usage scenario where a user runs a game application with multiple keys. As shown in FIG. 6, a dual-screen terminal is folded in a back direction, a front screen faces a user, the user holds the dual-screen terminal from two sides with both hands, a thumb A of the left hand and a thumb D of the right hand of the user contact the front screen, and an index finger B and a middle finger C of the left hand and an index finger E and a middle finger F of the right hand contact the back screen of the dual-screen terminal. When the user runs the game, the front screen and the back screen of the dual-screen terminal simultaneously detect the contact of finger surfaces of multiple fingers with the screens, where contact points of B, C, E and F on the back screen may be virtualized as four keys. Therefore user operation experience similar to a PSP handheld game console is implemented.

FIG. 7 is a flowchart of a control method according to optional embodiment two. Two screens of the dual-screen terminal are folded in the back direction, the front screen faces the user, the back screen faces away from the user, and the user holds the dual-screen terminal horizontally and activates a key game application on the front screen of the dual-screen terminal. At this time, the front touch screen and the back touch screen of the dual-screen terminal simultaneously detect effective contact regions A, B, C, D, E and F between finger surfaces of six fingers of the user and the screens. The dual-screen terminal may be divided into four quadrants 1, 2, 3 and 4 according to a coordinate system of the front screen. If it is assumed that the game application supports six virtual keys, effective pressing positions of the six virtual keys may correspond to screen region ranges where the four quadrants are located. For example, a key A corresponds to quadrants 1 and 3; a key D corresponds to quadrants 2 and 4; and keys B, C, E, and F are in one-to-one correspondence with quadrants 1, 3, 2, and 4. In this way, when a valid key point of the finger of the user falls within a corresponding quadrant, a processing unit may recognize this operation as a key value of a corresponding virtual key. It is determined whether a preset condition 101 is satisfied. The preset condition 101: The processing unit detects a coordinate value of a coordinate point of an independent finger on the dual-screen terminal. If the preset condition 101 is satisfied, a determination process flow of a preset condition 102 is entered. The terminal detects a pressure value of a mark pressure point of a finger surface of each finger of the user pressing the touch screen, and determines whether the preset condition 102 is satisfied. A pre-condition of the preset condition 102: The processing unit detects a pressure value set of each finger pressing the screen in real time, and the processing unit detects and calculates a pressing time value set of a finger surface pressing region in real time. The pressing time value set includes, but is not limited to, pressing starting time, pressing end time, and time when the pressure value of the mark pressure point in the pressing region reaches maximum or minimum; and the processing unit detects a set of calculated values of a pressing period of each pressing point in real time. The set of calculated values of the pressing period of the pressing point includes, but is not limited to, a time period value from starting to end of finger surface pressing, a time period value for the finger surface pressing pressure from minimum to maximum (or from the maximum to the minimum), a specified time period value for the finger surface pressing, and a time period value when a threshold value of a variation trend of pressing point pressure is reached from a certain time as starting time. The processing unit detects the pressure value of the mark pressure point of each finger in real time. The preset condition 102: In condition one, a touch detection unit determines that a pressure value of a mark pressure point of a coordinate value of a coordinate point of the finger on the front screen or the back screen reaches a threshold value of the variation trend of the pressing point pressure from small to large within a pressing time period. When the processing unit determines that the preset condition 102 is satisfied, a quadrant where the coordinate point is located is calculated, and a key value is reported to the game application for processing) according to a key value relationship of keys corresponding to the quadrants (referring to step 601 to step 604 shown in FIG. 7.

### Optional Embodiment Three

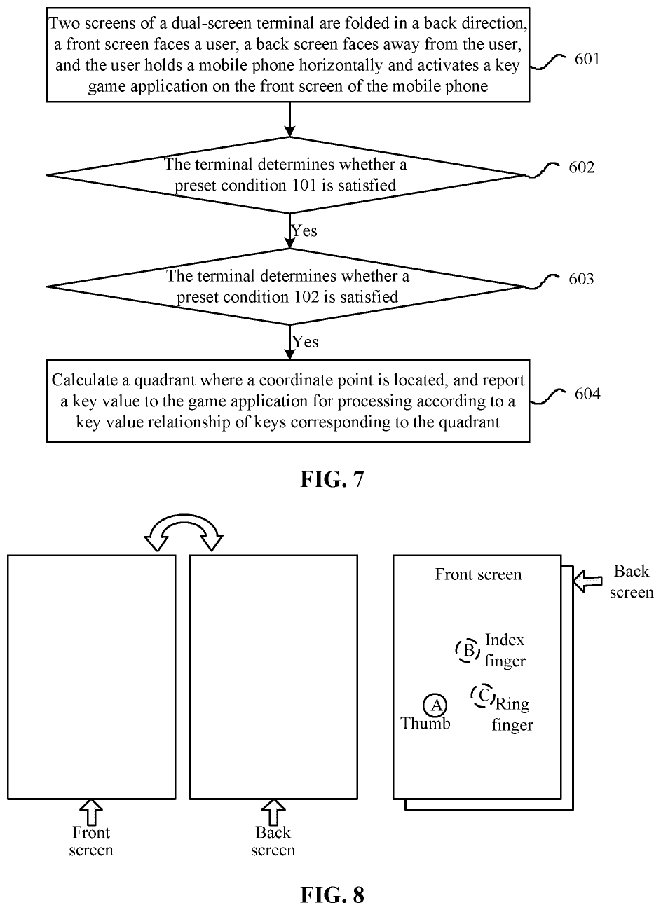

In this optional embodiment, accurate scaling of a map is mainly applied. FIG. 8 is an operation schematic diagram according to optional embodiment three. In this optional embodiment, a foldable dual-touch-screen terminal is taken as an example to describe a technical scheme. As shown in FIG. 8, the structure of the terminal consists of two screens. After being folded in half, the two touch screens face a front direction and a back direction respectively, where it is assumed that a front screen faces a user at this time. At this time, the user holds the terminal with the left hand, a finger surface of a thumb of the user contacts the front screen, and a contact point with the screen is a circular region A in FIG. 8. The user may use a finger surface of an index finger and a finger surface of a ring finger to contact the back screen, and contact points are circular regions B and C in FIG. 8 respectively. The user opens a map application software (APP) through the front screen, and when the finger of the user on the front screen and the fingers of the user on the back screen press the front screen and the back screen simultaneously, the processing unit performs an operation expected by the user according to a pressing operation of fingers of the user and a preset rule.

FIG. 9 is a flowchart of a control method according to optional embodiment three. The two screens of the dual-screen terminal are folded in a back direction, the front screen faces the user, and the back screen faces away from the user. The user opens a map application and a map interface of a location where the terminal is located is displayed on the front screen. At this time, the front touch screen and the back touch screen of the terminal simultaneously detect effective contact regions between the finger surfaces of the fingers of the user and the screens, and it is determined whether a preset condition 101 is satisfied. A pre-condition of the preset condition 101: A touch detection unit detects data values of sampling points in a region range of multi-point pressing of multiple fingers of the user in real time, and calculates information about coordinate points of finger mark positions according to the data values. A calculation method of the present application may include, but is not limited to, a following step: according to information about a coordinate set of effective contacting coordinate points generated by a touch screen contacted by each finger surface, the processing unit generates a finger surface outline map by an edge linear smoothing processing algorithm, and then calculates a geometric average center point according to a linear outline contour, where the center point is a coordinate value of a coordinate point of a mark position corresponding to a geometric region of the finger surface. The preset condition 101: In condition one, the touch detection unit detects a coordinate value A of a coordinate point of one independent finger on the front screen; in condition two, the touch detection unit detects a coordinate value B or C of a coordinate point of one independent finger on the back screen; and in condition three, the touch detection unit detects coordinate values B and C of coordinate points of two independent fingers on the back screen. If condition one and condition two in the preset condition 101 are satisfied, a determination process flow of a preset condition 102 is entered. If condition one and condition three in the preset condition 101 are satisfied, a determination process flow of a preset condition 103 is entered. A pre-condition of the preset condition 102 and the preset condition 103: The processing unit detects a pressure value set of each finger pressing the screen in real time; and the processing unit detects and calculates a pressing time value set of a finger surface pressing region in real time. The pressing time value set includes, but is not limited to, pressing starting time, pressing end time, time when the pressure value of the mark pressure point in the pressing region reaches maximum or minimum; and the processing unit detects a set of calculated values of a pressing time period of each pressing point in real time. The set of calculated values of the pressing time period of the pressing point includes, but is not limited to, a time period value from starting to end of finger surface pressing, a time period value for the finger surface pressing pressure from minimum to maximum (or from the maximum to the minimum), a specified time period value for the finger surface pressing, and a time period value when a threshold value of a variation trend of pressing point pressure is reached from a certain time as starting time. The processing unit detects a pressure value of each mark pressure point in real time. The preset condition 102: In condition one, a touch detection unit determines that a pressure value of a mark pressure point of the coordinate value A of the coordinate point of the thumb on the front screen reaches a threshold value of the variation trend of the pressing point pressure from small to large within a pressing time period; in condition two, when a difference between starting time of the pressing time period described in condition one and starting time of a pressing time period in which the back screen is contacted is within a preset threshold value range, and a difference between end time of the pressing time period described in condition one and end time of the pressing time period in which the back screen is contacted is within a preset threshold value range, the touch detection unit detects that a pressure value of a mark pressure point of a coordinate point on the back screen reaches the threshold value of the variation trend of the pressing point pressure from small to large within a pressing time period; and in condition three, at this time, a distance between the point A on the front screen and the coordinate value of the mark pressure point of the coordinate point on the back screen which is converted into a coordinate value on the front screen through coordinate systems is within a preset distance determination threshold value. When three conditions of the preset condition 102 are simultaneously satisfied, the processing unit performs an enlarged display processing operation on the map interface with the point A as a center point coordinate. Thereafter, when it is determined that a pressing trend of the user is stopped, the enlarged display processing operation is stopped. The preset condition 103: In condition one, the touch detection unit determines that the pressure value of the mark pressure point of the coordinate value A of the coordinate point of the thumb on the front screen reaches the threshold value of the variation trend of the pressing point pressure from small to large within a pressing time period; in condition two, when a difference between starting time of the pressing time period described in condition one and starting time of a pressing time period in which the back screen is contacted is within a preset threshold value range, and a difference between end time of the pressing time period described in condition one and end time of the pressing time period in which the back screen is contacted is within a preset threshold value range, the touch detection unit detects that a pressure value of a mark pressure point of a coordinate point (one of the point B or the point C, and both the point B and the point C exist simultaneously) on the back screen reaches the threshold value of the variation trend of the pressing point pressure from small to large within a pressing time period; and in condition three, at this time, a distance between the point A on the front screen and a coordinate value of a coordinate point satisfying condition two and converted onto the front screen through coordinate systems is within a preset distance determination threshold value. When three conditions of the preset condition 103 are simultaneously satisfied, the processing unit performs a shrink display processing operation on the map interface with the point A as a center point coordinate. Thereafter, when it is determined that the pressing trend of the user is stopped, the shrink display processing operation is stopped. In an embodiment, according to a theory of mechanics, in the preset condition 103, when the user presses the front screen and the back screen simultaneously with fingers of a single hand, on a premise that the screens of the terminal need to be kept vertical and upward, it is assumed that a point satisfying condition two in the preset condition 103 is the point B at this time, then coordinates of the point B and the point C in a coordinate system of the back screen are converted to coordinates of B′ and C′ in a coordinate system of the front screen through a corresponding conversion process of the coordinate system of the front screen and the coordinate system of the back screen, and then a distance value between the coordinate of the point A and the coordinate of the point B′, and a distance value between the coordinate of the point A and the coordinate of the point C′ are calculated, then at this time, the distance value between the point A and the point B′ is less than the distance between the point A and the point C′.

In an embodiment, in addition to a determination method for a trend of the magnitude of the finger pressing pressure described in this embodiment, a determination method for a variation trend of the area of the finger surface of the finger of the user or a finger sliding operation may also be included (referring to step 801 to step 806 shown in FIG. 9).

### Optional Embodiment Four

In this optional embodiment, waking up and unlocking of a mobile phone are mainly applied. This embodiment relates to a touch operation method for waking up and unlocking a black screen of a mobile phone. As shown in FIG. 10, for a terminal supporting dual screens, when two screens are folded in a back direction, a front screen faces a user and a back screen faces away from the user. The front screen and the back screen simultaneously detect an operation of contact, pressing or sliding of a finger of the user. A thumb of the user contacts a front touch screen region while finger surfaces of multiple fingers of the user contact a back touch screen region. The mobile phone is in a sleep and locked state, and both the front screen and the back screen do not light up. At this time, the user uses the thumb on the front screen to slide among coordinate points in sequence according to conditions such as a preset sliding path and a preset operation time period threshold value, where the coordinate points are coordinate points converted from the back screen to the front screen when the back screen is pressed by the fingers. In an example, a sliding path of the thumb exemplified in FIG. 10 is B->C->E->D->C. When preset conditions are satisfied, the terminal performs operations such as waking up the mobile phone and lighting up the front screen, or directly unlocking to enter a standby interface.

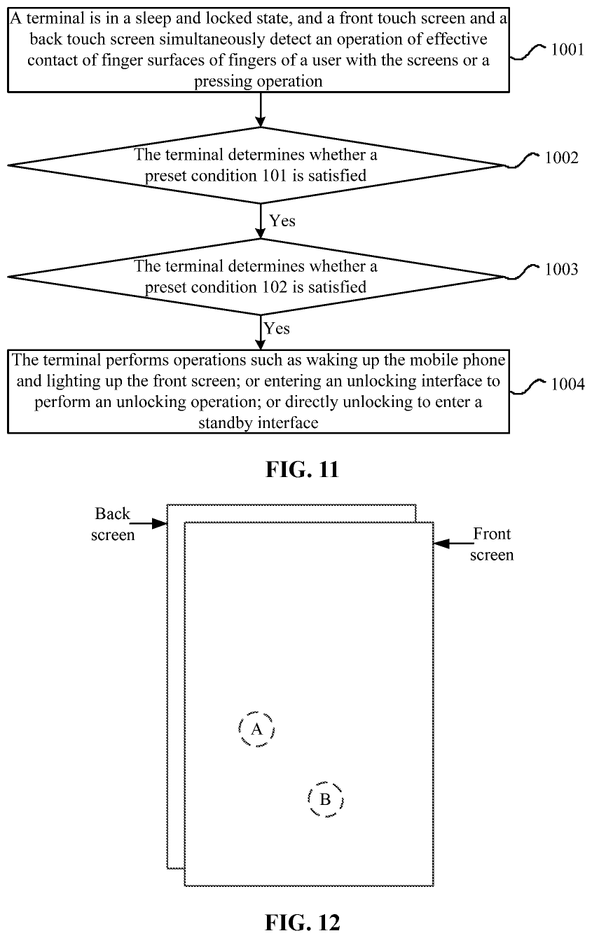

FIG. 11 is a flowchart of a control method according to optional embodiment four. The terminal is in the sleep and locked state, and the front touch screen and the back touch screen simultaneously detect an operation of effective contact of the finger surfaces of the fingers of the user with the screens or a pressing operation. It is determined whether a preset condition 101 is satisfied. The preset condition 101: A processing unit detects that finger surfaces of two fingers simultaneously contact the front screen and the back screen of the mobile phone on the front screen and the back screen. If the preset condition 101 is satisfied, a determination process flow of a preset condition 102 is entered. The terminal detects a mark coordinate point of a finger surface of each finger of the user on the front screen and the back screen, and determines whether the preset condition 102 is satisfied. The preset condition 102: In condition one, it is detected that four fingers are fixed on the back screen, and at the same time, it is detected that one finger slides on the front screen; and in condition two, a thumb slides among the coordinate points on the front screen, where the coordinate points are coordinate points converted from coordinate points of four fingers on the back screen to the front screen by the coordinate system of the front screen and the coordinate system of the back screen, and a sliding path and sequence are B->C->E->D->C. When the processing unit determines that the preset condition 102 is satisfied, the terminal performs operations such as waking up the mobile phone and lighting up the front screen; or entering an unlocking interface to perform an unlocking operation; or directly unlocking to enter a standby interface (referring to step 1001 to step 1004 shown in FIG. 11).

### Optional Embodiment Five

In this optional embodiment, dual-screen photographing is mainly applied. As shown in FIG. 12, this embodiment relates to an operation method based on a dual-screen mobile phone photographing technology. For a terminal supporting dual screens, when two screens are folded in a back direction, a front screen faces a user and a back screen faces away from the user. Assuming that the user is using a photographing application to take photos at this time, a photographing preview interface of the photographing application is displayed on the front screen of the mobile phone, and at this time, the user holds the mobile phone with a single hand. User operation scenario one is manual focusing. When one finger is used for clicking one coordinate point on the back screen, a processing unit converts a coordinate of the point into a coordinate of a corresponding point on the front screen, and the photographing application uses the coordinate point as a focus to perform an automatic focusing operation. User operation scenario two is quick photographing. The user uses two fingers to perform a touch operation on the back screen, one finger fixedly contacts the back screen, and the other finger clicks on the back screen, and at this time, the photographing application performs a shutter-pressing photographing operation.

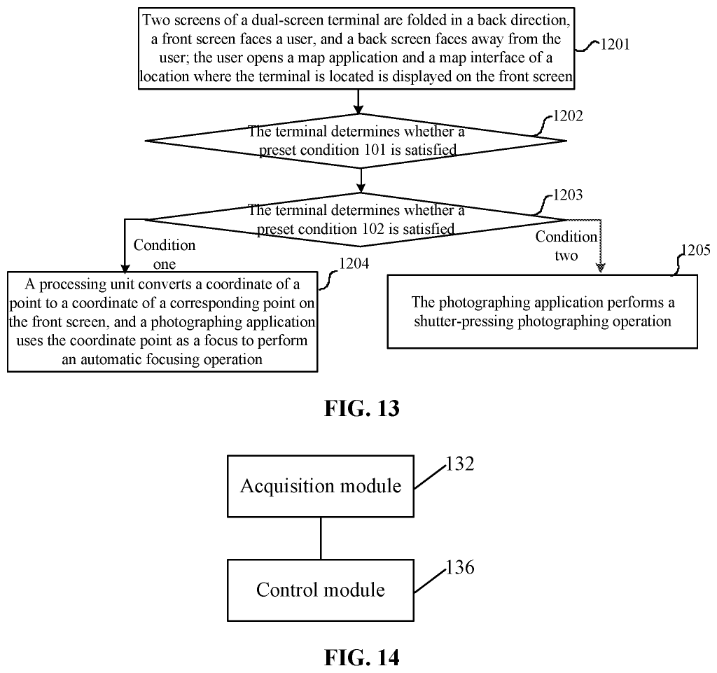

FIG. 13 is a flowchart of a control method according to optional embodiment five. The terminal is in a folded state, the front screen displays the photographing preview interface of the photographing application, and at this time, the back screen detects an operation of effective contact of finger surfaces of fingers of the user with the screens or a click operation. It is determined whether a preset condition 101 is satisfied. The preset condition 101: A touch detection unit detects a touch operation of a finger on the back screen. If the preset condition 101 is satisfied, a determination process flow of a preset condition 102 is entered, and it is determined whether the preset condition 102 is satisfied. The preset condition 102: In condition one, one finger single click operation is detected on the back screen, the processing unit converts a coordinate of the point into a coordinate of a corresponding point on the front screen, and the photographing application performs the automatic focusing operation with the coordinate point as the focus; in condition two, the back screen detects that one finger of the user fixedly contacts the back screen, the other finger performs one click operation on the back screen, and at this time, the photographing application performs the shutter-pressing photographing operation (referring to step 1201 to step 1205 shown in FIG. 13).

This embodiment provides the control method designed for the dual-screen terminal. The two touch screens of the dual-screen terminal can independently detect the touch operation of the user, and can simultaneously perform the determination and processing operations of conditions such as the variation trend and the magnitude of the pressure of the finger surface of the user pressing the touch screen; the size and the variation trend of the area of the finger surface; the distances and direction variations of a multi-finger surface sliding operation, so as to implement the functions and operations expected by the user. Furthermore, the user experience of the terminal supporting the multiple touch screens for the touch operations can be improved, and more application operation methods different from the single-screen terminal can be implemented.

Optimization of the scheme provided by this embodiment relative to the background includes, but is not limited to, the following: the embodiment provides the control method designed for characteristics of the touch operations of the dual-screen mobile phone, and the application of the method can effectively improve the user experience effect of the dual-screen smart terminal.

This embodiment does not increase additional costs on the basis of hardware in the implementation of technical functions.

From the description of the embodiment described above, it will be apparent to those skilled in the art that the methods in the embodiment described above may be implemented by software plus a necessary general-purpose hardware platform, or may of course be implemented by hardware. However, in many cases, the former is a preferred implementation. Based on this understanding, the technical scheme of the present application substantially, or the part contributing to the related art, may be embodied in the form of a software product. The computer software product is stored in a storage medium (such as a read-only memory (ROM), a random access memory (RAM), a magnetic disk or an optical disk) and includes several instructions for enabling a terminal device (which may be a mobile phone, a computer, a server, a network device or the like) to perform the method according to any one embodiment of the present application.

### Embodiment Two

In this embodiment, a control device is provided for implementing the above-mentioned embodiment and what has been described will not be repeated here. As used below, the term “module” may be software, hardware or a combination thereof capable of implementing predetermined functions. The device in the embodiment described below is implemented by software, but implementation by hardware or by a combination of software and hardware is also possible and conceived.

FIG. 14 is a structural block diagram of a control device according to this embodiment, the device is applied to a terminal including at least two touch screens, and as shown in FIG. 14, the device includes an acquisition module 132 and a control module 136.

(1) The acquisition module 132 is configured to acquire at least one piece of following touch information: first fingerprint touch information on a first touch screen of the terminal or second fingerprint touch information on a second touch screen of the terminal.

In an embodiment, in the case where the acquired touch information includes the first fingerprint touch information, the first fingerprint touch information includes at least one of the following: a pressure value, a touch region area, an acoustic wave or a light wave; in the case where the acquired touch information includes the second fingerprint touch information, the second fingerprint touch information includes at least one of the following: a pressure value, a touch region area, an acoustic wave or a light wave.

(2) The control module 136 is configured to control the terminal according to the acquired touch information.

Through the device shown in FIG. 14, at least one piece of the following touch information is acquired: the first fingerprint touch information on the first touch screen of the terminal or the second fingerprint touch information on the second touch screen of the terminal. The terminal is controlled according to the acquired touch information. That is, a corresponding control method is proposed for characteristics of touch operations of a multi-screen terminal, thereby solving that terminal control methods in the related art are all based on a single-screen terminal and no control method for multiple screens has been proposed, and effectively improving the user experience of the multi-screen terminal.

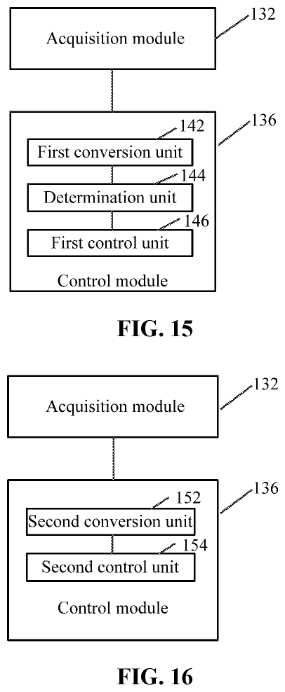

FIG. 15 is a structural block diagram of a control device according to another embodiment of the present application, and as shown in FIG. 15, the control module 136 includes a first conversion unit 142, a determination unit 144 and a first control unit 146.

(1) The first conversion unit 142 is configured to: in the case where the acquired touch information includes the first fingerprint touch information and the second fingerprint touch information, and each of the first fingerprint touch information and the second fingerprint touch information includes the pressure value, convert a coordinate point of a mark position of a force bearing point of the first fingerprint touch information onto the second touch screen according to a predetermined mode to obtain a coordinate position, which corresponds to the coordinate point of the mark position of the force bearing point on the first touch screen, on the second touch screen.

(2) The determination unit 144 is configured to determine whether a distance between the coordinate position, which corresponds to the coordinate point of the mark position of the force bearing point on the first touch screen, on the second touch screen and a coordinate point of a mark position on the second touch screen is within a preset range.

(3) The first control unit 146 is configured to: in the case where it is determined that the distance between the coordinate position, which corresponds to the coordinate point of the mark position of the force bearing point on the first touch screen, on the second touch screen and the coordinate point of the mark position of the force bearing point on the second touch screen is within the preset range, control the terminal with the coordinate point of the mark position of the force bearing point of the second fingerprint touch information as a center.

In an embodiment, the first conversion unit 142 is further configured to: in the case where the acquired touch information includes the first fingerprint touch information, and the first fingerprint touch information includes the pressure value, convert coordinate points of mark positions of at least two force bearing points on the first touch screen onto the second touch screen according to a predetermined mode to obtain at least two coordinate positions, which are in one-to-one correspondence with the coordinate points of the mark positions of the at least two force bearing points on the first touch screen, on the second touch screen.

The determination unit 144 is further configured to determine whether a distance between every two coordinate positions in the at least two coordinate positions, which are in the one-to-one correspondence, on the second touch screen is within a preset range.

The first control unit 146 is further configured to: in the case where it is determined that the distance between the every two coordinate positions is within the preset range, control the terminal with one of the coordinate points of the mark positions of the at least two force bearing points on the first touch screen as a center.

In an embodiment, the above-mentioned predetermined mode includes the following: a state between the first touch screen and the second touch screen is determined according to an angle between the first touch screen and the second touch screen; a coordinate point of a mark position on the first touch screen is converted onto the second touch screen according to the state, or a coordinate point of a mark position on the second touch screen is converted onto the first touch screen according to the state.

FIG. 16 is a structural block diagram of a control device according to another embodiment of the present application, and as shown in FIG. 16, the control module 136 includes a second conversion unit 152 and a second control unit 154.

(1) The second conversion unit 152 is configured to: in the case where the acquired touch information includes the first fingerprint touch information and the second fingerprint touch information, and each of the first fingerprint touch information and the second fingerprint touch information includes the pressure value, convert coordinate points of one or more force bearing points on the second touch screen onto the first touch screen to obtain one or more coordinate positions, which are in one-to-one correspondence with the coordinate points of the mark positions of the one or more force bearing points on the second touch screen, on the first touch screen.

(2) The second control unit 154 is configured to control the terminal according to coordinate system positions where the one or more coordinate positions, which are in the one-to-one correspondence, on the first touch screen are located or coordinate system positions where the coordinate points of the one or more force bearing points on the second touch screen are located.

In an embodiment, the second conversion unit 152 is further configured to: in the case where the acquired touch information includes the first fingerprint touch information, and the first fingerprint touch information or the second fingerprint touch information includes the pressure value, convert coordinate points of one or more force bearing points on the first touch screen onto the second touch screen to obtain one or more coordinate positions, which are in one-to-one correspondence with the coordinate points of the mark positions of the one or more force bearing points on the first touch screen, on the second touch screen.

The second control unit 154 is further configured to control the terminal according to coordinate system positions where the one or more coordinate positions, which are in the one-to-one correspondence, on the second touch screen are located.

In an embodiment, the above-mentioned control module 136 is configured to control the terminal through the following mode: in the case where the acquired touch information includes the first fingerprint touch information and the second fingerprint touch information, and each of the first fingerprint touch information and the second fingerprint touch information includes the pressure value, controlling the terminal according to a variation trend of a pressure value indicated by the first fingerprint touch information and a variation trend of a pressure value indicated by the second fingerprint touch information.

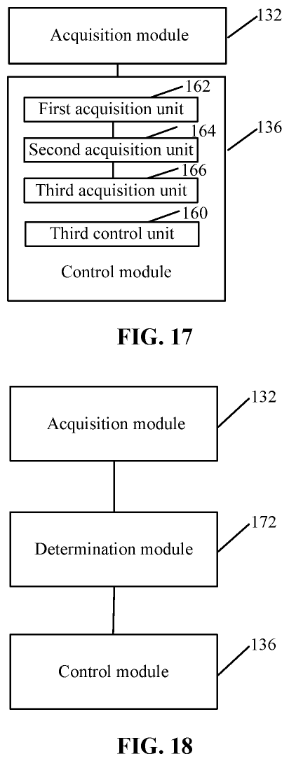

In an embodiment, FIG. 17 is a structural block diagram of a control device according to another embodiment of the present application. As shown in FIG. 17, the above-mentioned control module 136 includes a third control unit 160. The third control unit 160 is configured to: in the case where the acquired touch information includes the first fingerprint touch information and the second fingerprint touch information, and each of the first fingerprint touch information and the second fingerprint touch information includes the touch region area, control the terminal according to a distance between an average center point of a touch region area of the first fingerprint touch information and an average center point of a touch region area of the second fingerprint touch information.

In an embodiment, as shown in FIG. 17, the control module 136 further includes a first acquisition unit 162, a second acquisition unit 164 and a third acquisition unit 166.

(1) The first acquisition unit 162 is configured to: before controlling the terminal according to the distance between the average center point of the touch region area of the first fingerprint touch information and the average center point of the touch region area of the second fingerprint touch information, acquire a first coordinate point set corresponding to the touch region area of the first fingerprint touch information according to a touch region area received by the first touch screen and a second coordinate point set corresponding to the touch region area of the second fingerprint touch information according to a touch region area received by the second touch screen.

(2) The second acquisition unit 164 is configured to process the first coordinate point set and the second coordinate point set by a specified algorithm to obtain a touch region outline map.

(3) The third acquisition unit 166 is configured to acquire the average center point of the touch region area of the first fingerprint touch information and the average center point of the touch region area of the second fingerprint touch information according to the touch region outline map.

In an embodiment, the above-mentioned control module 136 is configured to control the terminal through the following mode: in the case where the acquired touch information includes the first fingerprint touch information and the second fingerprint touch information, and each of the first fingerprint touch information and the second fingerprint touch information includes the touch region area, controlling the terminal according to a variation trend of a touch region area indicated by the first fingerprint touch information and a variation trend of a touch region area indicated by the second fingerprint touch information.

FIG. 18 is a structural block diagram of a control device according to another embodiment of the present application. As shown in FIG. 18, in addition to the modules shown in FIG. 14, the device further includes a determination module 172.

(1) The determination module 172 is configured to: before controlling the terminal according to the acquired touch information, determine that the acquired touch information satisfies a preset condition.

In an embodiment, the preset condition includes at least one of the following: a value of a parameter included in the acquired touch information is not equal to 0, or contact time included in the acquired touch information is within a preset range.

In an embodiment, an operation corresponding to the above-mentioned control includes, but is not limited to, moving an application icon, controlling the size of an application interface, waking up and unlocking the terminal, or performing dual-screen photographing.

This embodiment is illustrated below in conjunction with an example.

In this example, a device supporting touch operations of a dual-screen smart terminal is provided. The device includes a processing unit, a touch screen unit, a touch detection unit, a pressure detection unit and the like. The processing unit may be abstracted as an operation processing unit of the terminal, and may include a central processing unit (CPU) of the terminal, an assistant-central processing unit (ACPU) of the terminal or the like, which is equivalent to a human brain and is responsible for overall operation and processing work of the terminal. The touch screen unit, that is, a touch screen supporting pressure sensing or multi-point touch, may be divided into multiple screens. In the present application, two touch screens are taken as a typical scenario to describe the technical scheme. When the number of screens is multiple, all technical schemes related to the technical scheme of the present application are within the scope of the present application. For the touch detection unit, for a user in a time period, the processing unit may recognize and determine data values of sampling points in a region range of multi-point pressing of multiple fingers through a multi-point touch detection unit. In an embodiment, the processing unit may calculate information about coordinate points of finger mark positions of finger surfaces of multiple fingers. For the pressure detection unit, for the user in a time period, the processing unit may recognize and determine a pressure value set of sampling points in a pressing region of the fingers of the user through the multi-point pressure detection unit. In an embodiment, the processing unit may calculate a pressure value of a mark pressure point of each finger surface. In an embodiment, the processing unit may calculate a trend value of a pressure variation of a pressure point of each finger surface.

In an embodiment, the device described in this example is also applicable to a terminal supporting multiple screens.

In an embodiment, the above-mentioned modules may be implemented by software or hardware. Implementation by hardware may, but may not necessarily, be performed in the following manner: the above-mentioned modules are located in the same processor or located in different processors in any combination form.

### Embodiment Three

The embodiment of the present application further provides a storage medium including a stored program. The program, when executed, performs any one of the above-mentioned methods.

In an embodiment, the above-mentioned storage medium may be configured to store program codes for performing steps described below.

At least one piece of the following touch information is acquired: first fingerprint touch information on a first touch screen of the terminal and second fingerprint touch information on a second touch screen of the terminal.

The terminal is controlled according to the acquired touch information.

In an embodiment, the above-mentioned storage medium may include, but is not limited to, a universal serial bus (USB) flash disk, an ROM, an RAM, a mobile hard disk, a magnetic disk, an optical disk or another medium capable of storing the program codes.

The embodiment of the present application further provides a processor. The processor is configured to execute a program. The program, when executed, performs any one of the above-mentioned methods.

In an embodiment, the above-mentioned program is configured to perform steps described below.

At least one piece of the following touch information is acquired: first fingerprint touch information on a first touch screen of the terminal and second fingerprint touch information on a second touch screen of the terminal.

The terminal is controlled according to the acquired touch information.

The examples in this embodiment may refer to the examples described in the above-mentioned embodiments, and will not be repeated here in this embodiment.

Apparently, it should be understood by those skilled in the art that the above-mentioned modules or steps of the present application may be implemented by a general-purpose computing device, the modules or steps may be concentrated on a single computing device or distributed on a network composed of multiple computing devices. In an embodiment, the modules or steps may be implemented by program codes executable by the computing device, so that the modules or steps may be stored in a storage device and executed by the computing device. Moreover, in some cases, the illustrated or described steps may be executed in sequences different from those described herein, or the modules or steps may be made into various integrated circuit modules separately, or multiple modules or steps therein may be made into a single integrated circuit module for implementation. In this way, the present application is not limited to any specific combination of hardware and software.

The above are only embodiments of the present application and are not intended to limit the present application.

1. A control method, applied to a terminal comprising at least two touch screens, comprising:
acquiring at least one piece of following touch information: first fingerprint touch information on a first touch screen of the terminal or second fingerprint touch information on a second touch screen of the terminal; and
controlling the terminal according to the acquired touch information.

2. The method of claim 1, wherein
in a case where the acquired touch information comprises the first fingerprint touch information, the first fingerprint touch information comprises at least one of following parameters: a pressure value, a touch region area, an acoustic wave, or a light wave; or
in a case where the acquired touch information comprises the second fingerprint touch information, the second fingerprint touch information comprises at least one of following parameters: a pressure value, a touch region area, an acoustic wave, or a light wave.

3. The method of claim 2, wherein in a case where the acquired touch information comprises the first fingerprint touch information and the second fingerprint touch information, controlling the terminal according to the acquired touch information comprises:
in a case where each of the first fingerprint touch information and the second fingerprint touch information comprises the pressure value, converting a coordinate point of a mark position of a force bearing point on the first touch screen onto the second touch screen according to a predetermined mode to obtain a coordinate position, which corresponds to the coordinate point of the mark position of the force bearing point on the first touch screen, on the second touch screen;
determining whether a distance between the coordinate position, on the second touch screen and a coordinate point of a mark position of a force bearing point on the second touch screen is within a preset range; and
in response to determining that the distance between the coordinate position on the second touch screen and the coordinate point of the mark position of the force bearing point on the second touch screen is within the preset range, controlling the terminal with the coordinate point of the mark position of the force bearing point on the second touch screen as a center.

4. The method of claim 2, wherein in a case where the acquired touch information comprises the first fingerprint touch information, controlling the terminal according to the acquired touch information comprises:
in a case where the first fingerprint touch information comprises the pressure value, converting coordinate points of mark positions of at least two force bearing points on the first touch screen onto the second touch screen according to a predetermined mode to obtain at least two coordinate positions, which are in one-to-one correspondence with the coordinate points of the mark positions of the at least two force bearing points on the first touch screen, on the second touch screen;
determining whether a distance between every two coordinate positions in the at least two coordinate positions on the second touch screen is within a preset range; and
in response to determining that the distance between the every two coordinate positions is within the preset range, controlling the terminal with one of the coordinate points of the mark positions of the at least two force bearing points on the first touch screen as a center.

5. The method of claim 3, wherein the predetermined mode comprises:
determining a state between the first touch screen and the second touch screen according to an angle between the first touch screen and the second touch screen; and
converting a coordinate point of a mark position on the first touch screen onto the second touch screen according to the state, or converting a coordinate point of a mark position on the second touch screen onto the first touch screen according to the state.

6. The method of claim 2, wherein in a case where the acquired touch information comprises the first fingerprint touch information and the second fingerprint touch information, controlling the terminal according to the acquired touch information comprises:
in a case where each of the first fingerprint touch information and the second fingerprint touch information comprises the pressure value, converting a coordinate point of a mark position of at least one force bearing point on the second touch screen onto the first touch screen to obtain at least one coordinate position, which is in one-to-one correspondence with the coordinate point of the mark position of the at least one force bearing point on the second touch screen, on the first touch screen; and
controlling the terminal according to a coordinate system position where the at least one coordinate position on the first touch screen is located and a coordinate system position where a coordinate point of a mark position of at least one force bearing point on the first touch screen is located.

7. The method of claim 2, wherein in a case where the acquired touch information comprises the first fingerprint touch information, controlling the terminal according to the acquired touch information comprises:
in a case where the first fingerprint touch information comprises the pressure value, converting a coordinate point of a mark position of at least one force bearing point on the first touch screen onto the second touch screen to obtain at least one coordinate position, which is in one-to-one correspondence with the coordinate point of the mark position of the at least one force bearing point on the first touch screen, on the second touch screen; and
controlling the terminal according to a coordinate system position where the at least one coordinate position on the second touch screen is located.

8. The method of claim 2, wherein in a case where the acquired touch information comprises the first fingerprint touch information and the second fingerprint touch information, and each of the first fingerprint touch information and the second fingerprint touch information comprises the pressure value, controlling the terminal according to the acquired touch information comprises:
controlling the terminal according to a variation trend of a pressure value indicated by the first fingerprint touch information and a variation trend of a pressure value indicated by the second fingerprint touch information.

9. The method of claim 2, wherein in a case where the acquired touch information comprises the first fingerprint touch information and the second fingerprint touch information, controlling the terminal according to the acquired touch information comprises:
in a case where each of the first fingerprint touch information and the second fingerprint touch information comprises the touch region area, controlling the terminal according to a distance between an average center point of a touch region area of the first fingerprint touch information and an average center point of a touch region area of the second fingerprint touch information.

10. The method of claim 9, before controlling the terminal according to the distance between the average center point of the touch region area of the first fingerprint touch information and the average center point of the touch region area of the second fingerprint touch information, further comprising:
acquiring a first coordinate point set corresponding to the touch region area of the first fingerprint touch information according to a touch region area received by the first touch screen, and acquiring a second coordinate point set corresponding to the touch region area of the second fingerprint touch information according to a touch region area received by the second touch screen;
processing the first coordinate point set and the second coordinate point set by a specified algorithm to obtain a touch region outline map; and
acquiring the average center point of the touch region area of the first fingerprint touch information and the average center point of the touch region area of the second fingerprint touch information according to the touch region outline map.

11. The method of claim 2, wherein in a case where the acquired touch information comprises the first fingerprint touch information and the second fingerprint touch information, controlling the terminal according to the acquired touch information comprises:
in a case where each of the first fingerprint touch information and the second fingerprint touch information comprises the touch region area, controlling the terminal according to a variation trend of a touch region area indicated by the first fingerprint touch information and a variation trend of a touch region area indicated by the second fingerprint touch information.

12. The method of claim 1, wherein before controlling the terminal according to the acquired touch information, further comprising:
determining that at least one piece of the acquired touch information satisfies a preset condition;
wherein the preset condition comprises at least one of: a value corresponding to a parameter comprised in the acquired touch information being not equal to 0, or contact time comprised in the acquired touch information being within a preset range.

13. The method of claim 1, wherein controlling the terminal comprises at least one of:
moving an application icon, controlling a size of an application interface, waking up and unlocking the terminal, or performing dual-screen photographing.

14. A control device, applied to a terminal comprising at least two touch screens, comprising:
an acquisition module, configured to acquire at least one piece of following touch information: first fingerprint touch information on a first touch screen of the terminal or second fingerprint touch information on a second touch screen of the terminal; and
a control module, configured to control the terminal according to the acquired touch information.

15. The device of claim 14, wherein
in a case where the acquired touch information comprises the first fingerprint touch information, the first fingerprint touch information comprises at least one of: a pressure value, a touch region area, an acoustic wave or a light wave; or
in a case where the acquired touch information comprises the second fingerprint touch information, the second fingerprint touch information comprises at least one of following parameters: a pressure value, a touch region area, an acoustic wave or a light wave.

16. The device of claim 15, wherein the control module comprises:
a first conversion unit, configured to: in a case where the acquired touch information comprises the first fingerprint touch information and the second fingerprint touch information, and each of the first fingerprint touch information and the second fingerprint touch information comprises the pressure value, convert a coordinate point of a mark position of a force bearing point on the first touch screen onto the second touch screen according to a predetermined mode to obtain a coordinate position, which corresponds to the coordinate point of the mark position of the force bearing point on the first touch screen, on the second touch screen;
a determination unit, configured to determine whether a distance between the coordinate position on the second touch screen and a coordinate point of a mark position of a force bearing point on the second touch screen is within a preset range; and
a first control unit, configured to: in response to determining that the distance between the coordinate position on the second touch screen and the coordinate point of the mark position of the force bearing point on the second touch screen is within the preset range, control the terminal with the coordinate point of the mark position of the force bearing point on the second touch screen as a center.

17. The device of claim 16, wherein
the first conversion unit is further configured to: in a case where the acquired touch information comprises the first fingerprint touch information, and the first fingerprint touch information comprises the pressure value, convert coordinate points of mark positions of at least two force bearing points on the first touch screen onto the second touch screen according to a predetermined mode to obtain at least two coordinate positions, which are in one-to-one correspondence with the coordinate points of the mark positions of the at least two force bearing points on the first touch screen, on the second touch screen;
the determination unit is further configured to determine whether a distance between every two coordinate positions in the at least two coordinate positions on the second touch screen is within a preset range; and
the first control unit is further configured to: in response to determining that the distance between the every two coordinate positions is within the preset range, control the terminal with one of the coordinate points of the mark positions of the at least two force bearing points on the first touch screen as a center.

18-26. (canceled)

27. A storage medium, comprising a stored program, wherein the program, when executed, performs the method of claim 1.

28. A processor, which is configured to execute a program, wherein the program, when executed, performs the method of claim 1.

29. The method of claim 4, wherein the predetermined mode comprises:
determining a state between the first touch screen and the second touch screen according to an angle between the first touch screen and the second touch screen; and
converting a coordinate point of a mark position on the first touch screen onto the second touch screen according to the state, or converting a coordinate point of a mark position on the second touch screen onto the first touch screen according to the state.
